(19) United States
(12) Patent Application Publication
(10) Pub. No.: US 2006/0293810 A1
(43) Pub. Date: Dec. 28, 2006

(54) Mobile robot and a method for calculating position and posture thereof

(75) Inventor: Hideichi Nakamoto, Kanagawa-ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/396,471

(22) Filed: Apr. 4, 2006

(30) Foreign Application Priority Data
Jun. 13, 2005 (JP) 2005-172854

(51) Int. Cl. G05D 1/00; G01C 22/00

(52) U.S. Cl. 701/28; 701/23

(57) ABSTRACT

A map data memory stores map data of a movement region, position data of a marker at a predetermined place in the movement region, identification data of the marker, and position data of a boundary line near the marker in the movement region. A marker detection unit detects the marker in an image, based on the position data of the marker and the identification data. A boundary line detection unit detects the boundary line near the marker from the image. A parameter calculation unit calculates a parameter of the boundary line in the image. A position posture calculation unit calculates a position and a posture of the mobile robot in the movement region, based on the parameter and the position data of the boundary line.

### CROSS-REFERENCE TO RELATED APPLICATIONS

This application is based upon and claims the benefit of priority from prior Japanese Patent Application No.2005-172854, filed on Jun. 13, 2005; the entire contents of which are incorporated herein by reference.

### FIELD OF THE INVENTION

The present invention relates to a mobile robot and a method for calculating position and posture of a mobile robot autonomously traveling to a destination.

### BACKGROUND OF THE INVENTION

Recently, a mobile robot which recognizes a surrounding environment and autonomously travels while localizing a self-apparatus and avoiding obstacles is developed. In an autonomous traveling system of such mobile robot, it is important that a position (location) of the self-apparatus (mobile robot) is exactly detected.

As a method for detecting a self-location of the mobile robot, first, a plurality of landmarks are detected from an image photographed by a camera mounted on the mobile robot. Based on the extracted landmark and absolute coordinate values of the landmarks (previously stored in a storage apparatus such as a memory), the mobile robot detects its position. This method is disclosed in Japanese Patent Disclosure (Kokai) 2004-216552.

In this method, a marker composed by a light emitting device is a landmark. By setting many landmarks in a room, the marker is certainly detected from various environments, and the location of the robot is detected.

However, in the above method, in case of detecting the self-location of the robot based on a location of the marker, it is necessary that many markers are photographed by the camera. Accordingly, many markers are set in the environment in which the robot is moving. In this case, the cost increases and its appearance is undesirable.

In case of detecting the marker from a camera image, it takes a long time for the robot to previously search many markers in the environment. Furthermore, in case of calculating the location of the robot, absolute coordinate values of many markers are exactly necessary. Accordingly, a user must previously input accurate absolute coordinate values of many markers to the robot, and this input working is troublesome for the user.

Furthermore, the marker is discriminated by detecting a flashing period of one light emitting element or a pattern of the flashing period. In this case, in a complicated environment in which many obstacles exist, a possibility that the marker is erroneously detected becomes high.

### SUMMARY OF THE INVENTION

The present invention is directed to a mobile robot and a method for accurately calculating a position of the mobile robot by detecting a marker in an environment.

According to an aspect of the present invention, there is provided a mobile robot comprising: a map data memory configured to store map data of a movement region, position data of a marker at a predetermined place in the movement region, identification data of the marker, and position data of a boundary line near the marker in the movement region; a marker detection unit configured to detect the marker from an image, based on the position data of the marker and the identification data; a boundary line detection unit configured to detect the boundary line near the marker from the image; a parameter calculation unit configured to calculate a parameter of the boundary line in the image; and a position posture calculation unit configured to calculate a position and a posture of the mobile robot in the movement region, based on the parameter and the position data of the boundary line.

According to another aspect of the present invention, there is also provided a method for calculating a position and a posture of a mobile robot, comprising: storing map data of a movement region, position data of a marker at a predetermined place in the movement region, identification data of the marker, and position data of a boundary line near the marker in the movement region; detecting the marker from an image, based on the position data of the marker and the identification data; detecting the boundary line near the marker from the image; calculating a parameter of the boundary line in the image; and calculating a position and a posture of the mobile robot in the movement region, based on the parameter and the position data of the boundary line.

According to still another aspect of the present invention, there is also provided a marker located in a movement region of a robot, the marker being detected by the robot and used for calculating a position and a posture of the robot, comprising:

a plurality of light emitting elements; and a drive unit configured to drive the plurality of light emitting elements to emit at a predetermined interval or in predetermined order as identification data of the marker.

### BRIEF DESCRIPTION OF THE DRAWINGS

FIG. 1 is a block diagram of a mobile robot according to one embodiment of the present invention.

FIG. 2 is a schematic diagram of map data stored in a map data memory in FIG. 1

FIG. 3 is a schematic diagram of component of the mobile robot.

FIGS. 4A and 4b are schematic diagrams of component of a marker according to one embodiment of the present invention.

FIGS. 5A and 5B are schematic diagrams of light emitting pattern of the marker in FIG. 4A.

FIG. 6 is a schematic diagram of component of the marker according to another embodiment of the present invention.

FIG. 7 is a schematic diagram of lighting area of the marker.

FIG. 8 is a flow chart of autonomous traveling processing of the mobile robot according to one embodiment of the present invention.

FIG. 9 is a flow chart of calculation processing of position and posture in FIG. 8.

FIGS. 10A, 10B and 10C are schematic diagrams of the marker detected from a camera image.

FIG. 11 is a schematic diagram of a coordinate system used for calculation of position and posture of the mobile robot.

FIG. 12 is a flow chart of map data creation processing according to one embodiment of the present invention.

FIG. 13 is a moving locus of the mobile robot in the map data creation processing.

FIGS. 14A and 14B are schematic diagrams of detection processing of neighboring boundary line of the marker according to one embodiment of the present invention.

### DETAILED DESCRIPTION OF THE EMBODIMENTS

Hereinafter, various embodiments of the present invention will be explained by referring to the drawings. The present invention is not limited to the following embodiments.

In embodiments of the present invention, a marker identifiable by a light emission pattern and a boundary line near the marker are detected from an image photographed by a camera. Based on the boundary line and map data (position data of the marker and the boundary line) previously stored in a memory, a position and a posture of an apparatus (mobile robot) is calculated.

The marker is a landmark located at a predetermined place in a mobile region allowing a robot to calculate its position and posture. The boundary line is a line near the marker, which divides the inside of the moving region into a plurality of objects (areas).

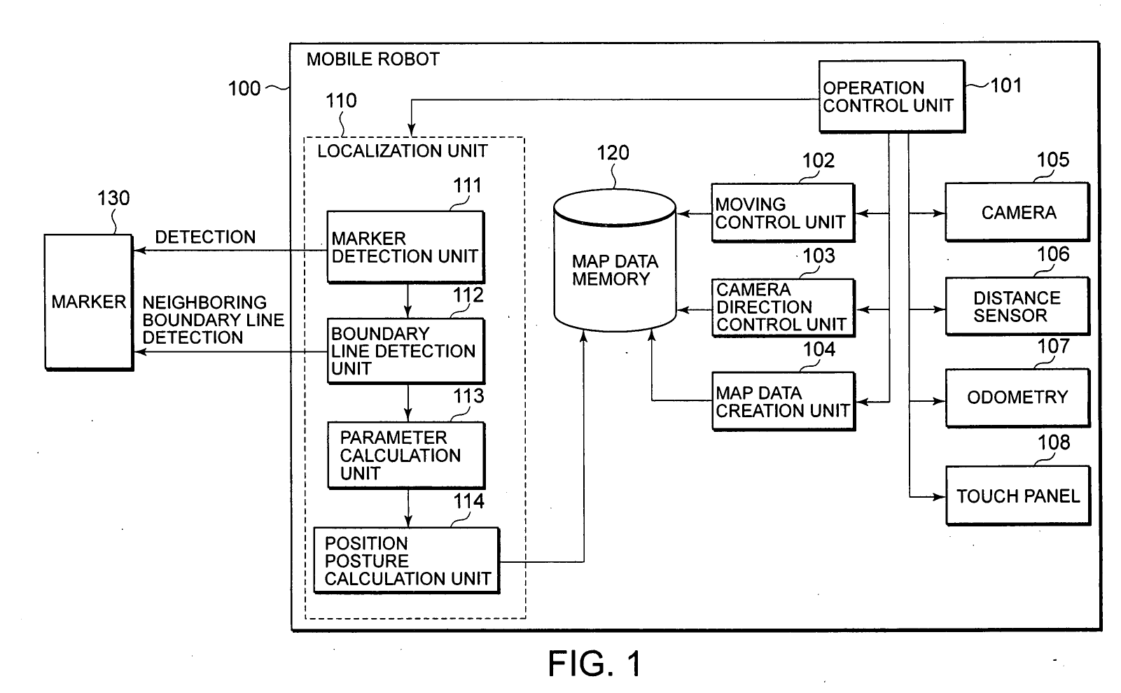

FIG. 1 is a block diagram of a mobile robot 100 according to one embodiment of the present invention. In FIG. 1, as a main software component, the mobile robot 100 comprises an operation control unit 101, a moving control unit 102, a camera direction control unit 103, a map data creation unit 104, and a localization unit 110.

Furthermore, as a main hardware component, the mobile robot 100 comprises a camera 105, a distance sensor 106, an odometry 107, a touch panel 108, and a map data memory 120.

A marker 130 is previously located in the moving region of the mobile robot 100, is detected by the mobile robot 100, and is used for calculating a position and a posture of the mobile robot 100. The marker 130 is set adjacent to a boundary line parallel with a floor in the moving region, for example, a boundary line between a wall and a ceiling, a boundary line between a floor and an object set on the floor, or a boundary line dividing a plurality of objects.

The marker 130 has only component and a size to detect from a camera image and to specify its position and identification. Accordingly, the marker 130 can be small-sized, and possibility that appearance is unattractive can be reduced.

The operation control unit 101 controls processing of the moving control unit 102, the camera direction control unit 103, the map data creation unit 104, the localization unit 110, the camera 105, the distance sensor 106, the odometry 107, and the touch panel 108 in order to control operation of the mobile robot 100.

The moving control unit 102 controls operation of a moving mechanism (not shown) by referring to position data (of the mobile robot) calculated by the localization unit 110. The moving mechanism is, for example, a wheel and a wheel drive motor to drive the wheel.

The camera direction control unit 103 controls a drive apparatus (not shown) for changing an optical axis direction of the camera 105 in order for the camera 105 to photograph the marker 130.

The map data creation unit 104 creates map data (to be stored in the map data memory 120) based on information obtained using the distance sensor 106 and the odometry 107 while moving along an object (such as a wall) in the moving region.

The camera 105 is an image pickup apparatus to photograph an image, which may be one apparatus. Otherwise, the camera 105 may be composed by a plurality of image pickup apparatuses to detect information (including position) of an object from images photographed by the plurality of image pickup apparatuses. The camera 105 can be any image pickup apparatus generally used such as a CCD (Charge Coupled Device). If the marker 130 has an infrared ray LED, the camera 105 includes an image pickup apparatus detecting infrared rays.

The distance sensor 106 detects a distance from the apparatus (mobile robot) to a surrounding object, and can be any sensor generally used such as an ultrasonic sensor. The odometry 107 estimates the position of the mobile robot 100 based on distance traveled. Distance may be measured by, for example, the rotation of a wheel. The touch panel 108 displays map data, and receives input of indicated data by a user's touching with a finger or a special pen.

The localization unit 110 calculates a position and a posture of the mobile robot 10, which comprises a marker detection unit 111, a boundary line detection unit 112, a parameter calculation unit 113, and a position posture calculation unit 114.

The marker detection unit 111 obtains an image photographed by the camera 105, and detects position data (in three-dimensional coordinate) of the marker 130 and identification data to uniquely identify the marker 130 from the image.

The boundary line detection unit 112 detects lines dividing the moving region (of the mobile robot 100) into a plurality of objects (areas), and selects a line neighboring the marker 130 (detected by the marker detection unit 111) from the lines.

The parameter calculation unit 113 calculates a parameter (including a position and a slope) of the boundary line (detected by the boundary line detection unit 112) in the image.

The position posture calculation unit 114 calculates a rotation angle (of the mobile robot 100) from a line perpendicular to the boundary line on a plane (floor) of the moving region, based on the slope included in the parameter of the boundary line (calculated by the parameter calculation unit 113). Furthermore, the position posture calculation unit 114 calculates a relative position (of the mobile robot 100) from the marker 130, based on the rotation angle and a height included in the position data of the marker 130 (previously stored in the map data memory 120).

The map data memory 120 correspondingly stores map data of the moving region (of the mobile robot 100), position data of the marker 130 in the moving region, and position data of the boundary line neighbored with the marker 130. The map data memory 120 is referred by the position posture calculation unit 114 in case of calculating a position and a posture of the mobile robot 100.

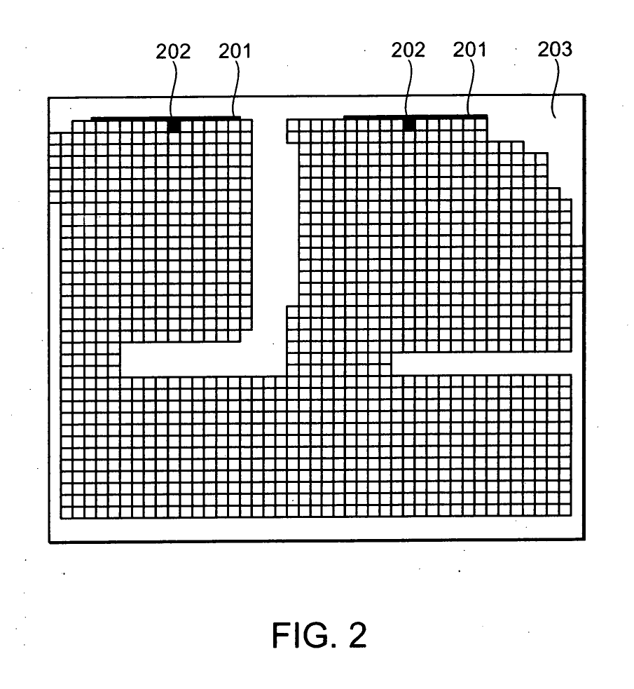

FIG. 2 is one example of map data stored in the map data memory 120. As shown in FIG. 2, the map data includes an area 203 in which the robot is not movable because of an obstacle (wall), a marker area 202 in which the marker 130 exists, and a boundary line area 201 neighboring the marker area 202. In FIG. 2, the map data is represented as a plan of the moving region (viewed from the upper part).

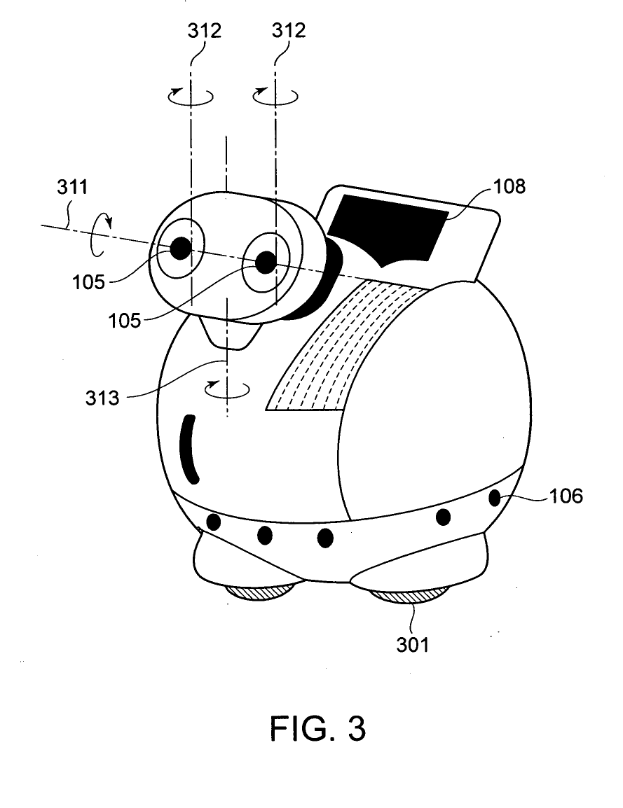

Next, examples of the mobile robot 100 and the marker 130 are explained. FIG. 3 is a schematic diagram of one example of the mobile robot 100.

As shown in FIG. 3, the mobile robot 100 includes a camera 105 such as a stereo camera having two image pickup apparatuses, five distance sensors 106 for detecting distance by ultrasonic wave, a touch panel 108, and wheels 301. Furthermore, the mobile robot 100 includes an odometry 107 (not shown) calculating a posture of the mobile robot 100 by detecting a rotation angle of the wheel 301.

The wheels 301 (a right wheel and a left wheel) respectively drive. By controlling two motors driving the right wheel and the left wheel, the mobile robot 100 can move along a straight line and around a circle, and revolve at that place. By the camera direction control unit 103, an optical axis of the camera 105 is rotated around a camera tilt rotation angle 311 at a predetermined angle (to rotate around top and bottom directions), and rotated around a camera pan rotation angle 312 at a predetermined angle (to rotate around right and left directions). Briefly, the optical axis of the camera 105 can turn to the marker 130.

Furthermore, in case of searching the marker 130, in order to search from a wider region, by rotating the entire head portion around a head portion-horizontal rotation axis 313, two image pickup apparatuses can be simultaneously rotated around the right and left directions.

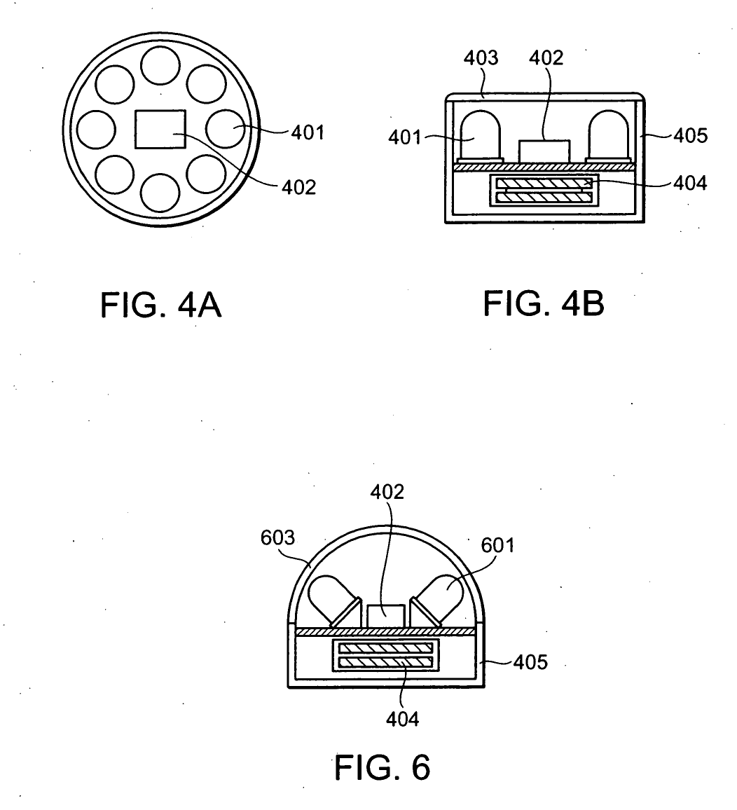

FIGS. 4A and 4B show one example of components of the marker 130. As shown in FIGS. 4A and 4B, the marker 130 includes a radiation LED 401, a drive circuit 402, an LED light diffusion cover 403, a battery 404, and a case 405.

The radiation LED 401 is an LED (Light Emitting Diode) to radiate by flowing current. The marker 130 includes a plurality of radiation LEDs 401.

The drive circuit 402 makes the plurality of LEDs radiate at a predetermined interval or a predetermined order. The radiation pattern is used as identification information to uniquely identify the marker 130.

The LED light diffusion cover 403 diffuses light from the LED 401, and makes the marker easy to detect from an image photographed by the camera 105 of the robot 100.

The battery 404 supplies power to the LED 401 and the drive circuit 402. The case 405 with the LED light diffusion cover 403 houses the LED 401, the drive circuit 402, and the battery 404.

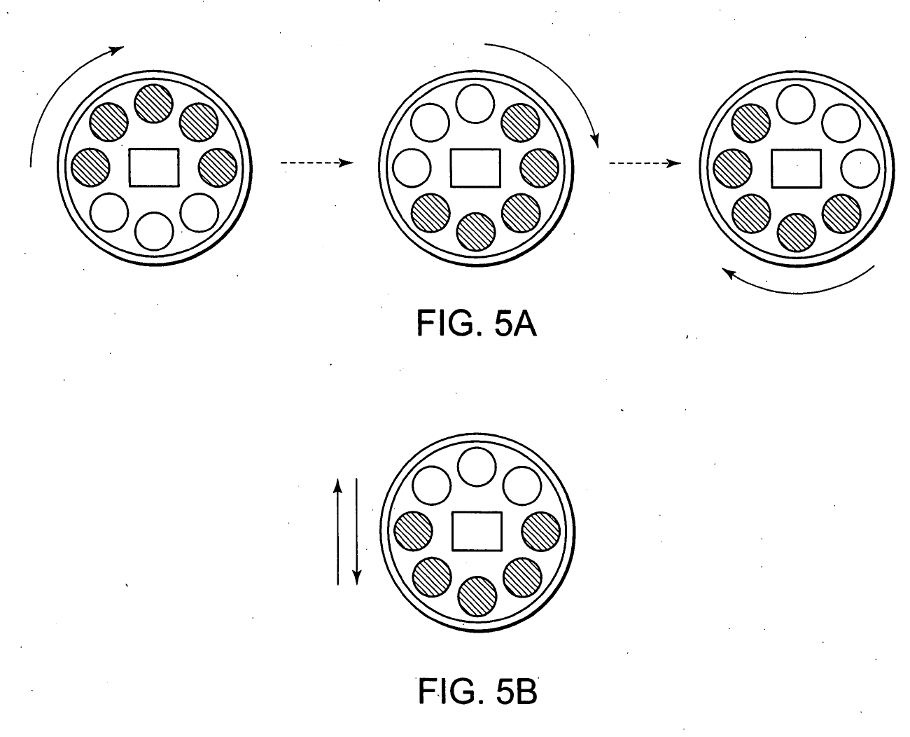

FIGS. 5A and 5B show examples of light emitting patterns of the marker 130 in FIGS. 4A and 4B. As shown in FIG. 5A, the plurality of LEDs 401 are respectively emitted in order of clockwise or counter clockwise. Furthermore, as shown in FIG. 5B, the plurality of LEDs may be emitted by changing a top half and a bottom half, or a right half and a left half.

In this way, by differently assigning a light emitting pattern to each marker 130 in order for the robot 100 to recognize the light emitting pattern, the marker 130 can be uniquely identified in a complicated environment. The light emitting pattern is called the identification information.

These light emitting patterns are shown as examples. By emitting the plurality of LEDs at predetermined interval or predetermined order, if only the light emitting pattern is usable as the identification information to uniquely identify the marker 130, all light emitting patterns can be used.

FIG. 6 shows an example of another component of the marker 130. In FIG. 6, the marker 130 includes an infrared ray LED 601, the drive circuit 402, a LED light diffusion cover 603, the battery 404, and the case 405.

The infrared ray LED 601 is an LED to radiate an infrared ray. The LED light diffusion cover 603 diffuses the infrared ray radiated from the infrared ray LED 601. Other component elements are the same as in FIG. 4 and their explanation is omitted.

A user cannot recognize the infrared ray radiated from the infrared ray LED 601. Accordingly, it has no difficulty in the user's life. Furthermore, by setting the LED 601 with slope and setting the cover 603 on the LED 601, the infrared ray can be diffused in circumference area of the marker 130. Accordingly, the marker 130 and the neighboring boundary line can be detected in a dark environment.

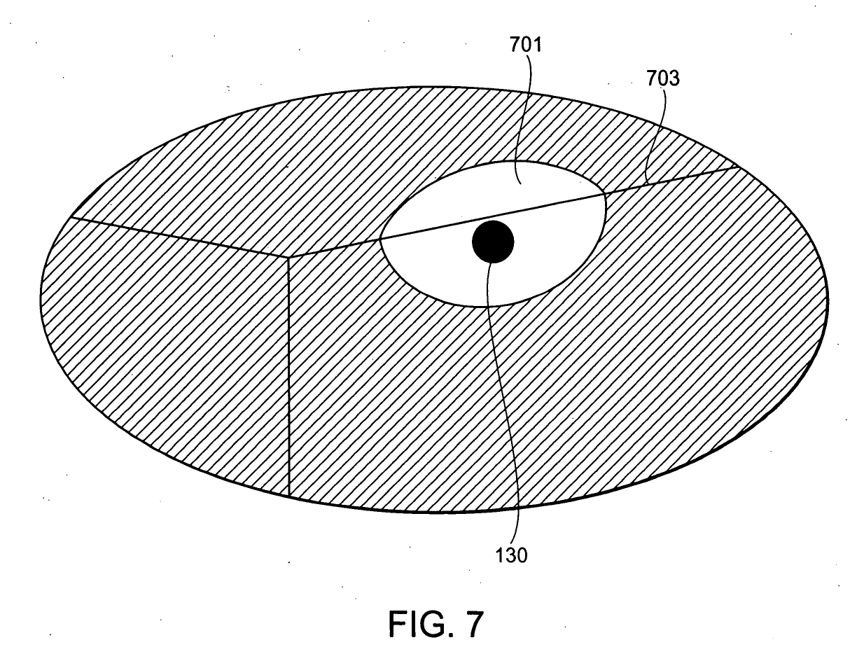

FIG. 7 shows one example of illumination area of the marker 130 of FIG. 6. As shown in FIG. 7, the marker 130 including the infrared ray LED is located adjacent to a boundary line 703 between a wall and a ceiling, and the infrared ray is illuminated onto a surrounding area 701 of the marker 130. Accordingly, the boundary line 703 can be detected.

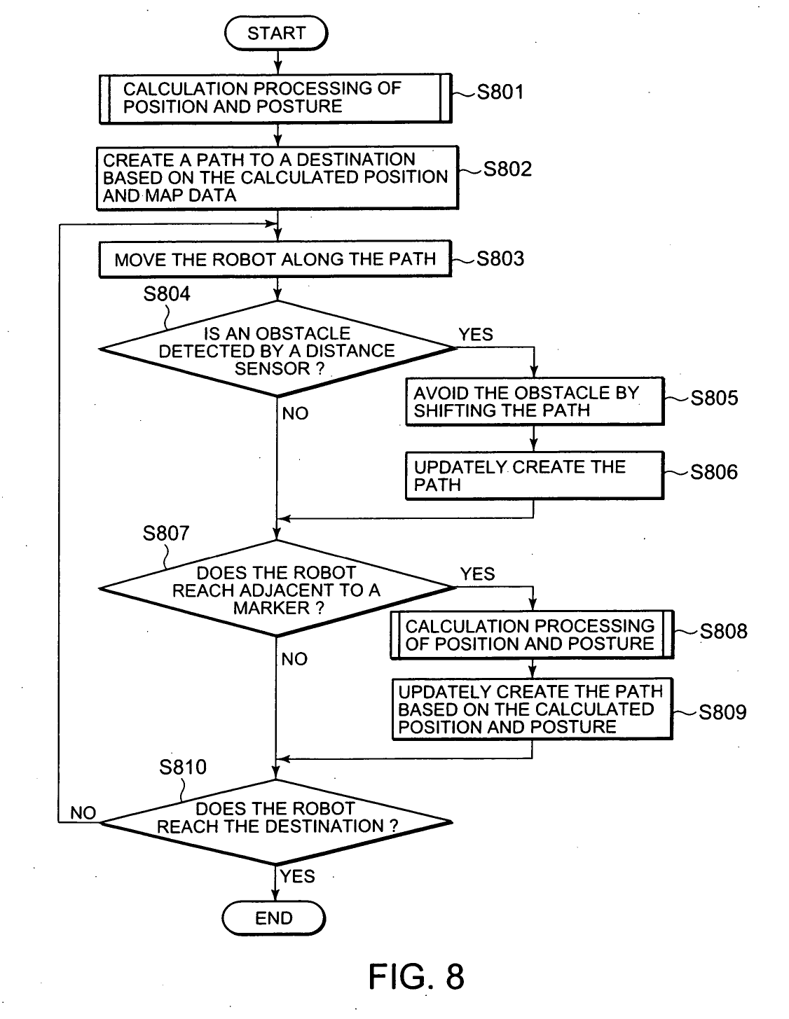

Next, autonomous traveling processing of the mobile robot 100 of an embodiment is explained. FIG. 8 is a flow chart of the autonomous traveling processing of the mobile robot 100 according to one embodiment.

First, in order to calculate an initial position and posture of the mobile robot 100, calculation processing of position and posture is executed (S801). Detail of the calculation processing is explained afterwards.

Next, the moving control unit 102 creates a moving path to a destination (target place) based on the present position data of the mobile robot 100 (by the calculation processing of position and posture) and map data stored in the map data memory 120 (S802).

Next, the moving control unit 102 controls a moving mechanism to move along the path (S803). During moving, the operation control unit 101 detects whether an obstacle exists on the path by the distance sensor (S804).

In case of detecting an obstacle (Yes at S804), the moving control unit 102 controls the moving mechanism to avoid the obstacle by shifting from the path (S805). Furthermore, by considering a shift quantity from the path, the moving control unit 102 updately creates the path (S806).

In case of not detecting an obstacle (No at S804), by referring to position data of the marker 130 stored in the map data memory 120, the moving control unit 102 decides whether the robot 100 reaches a position adjacent to the marker 130.

In case of reaching the position adjacent to the marker 130 (Yes at S807), the calculation processing of position and posture is executed again (S808). Furthermore, by considering the position and posture calculated, the moving control unit 102 updately creates the path (S809). In this way, by correcting a shift from the path while moving, the robot 100 can be controlled to reach the destination.

In case of not reaching adjacent to the marker 130 (No at S807), the moving control unit 102 decides whether the robot 100 reaches the destination (S810).

In case of not reaching the destination (No at S810), moving processing is repeated (S803). In case of reaching the destination (Yes at S810), autonomous traveling processing is completed (S810).

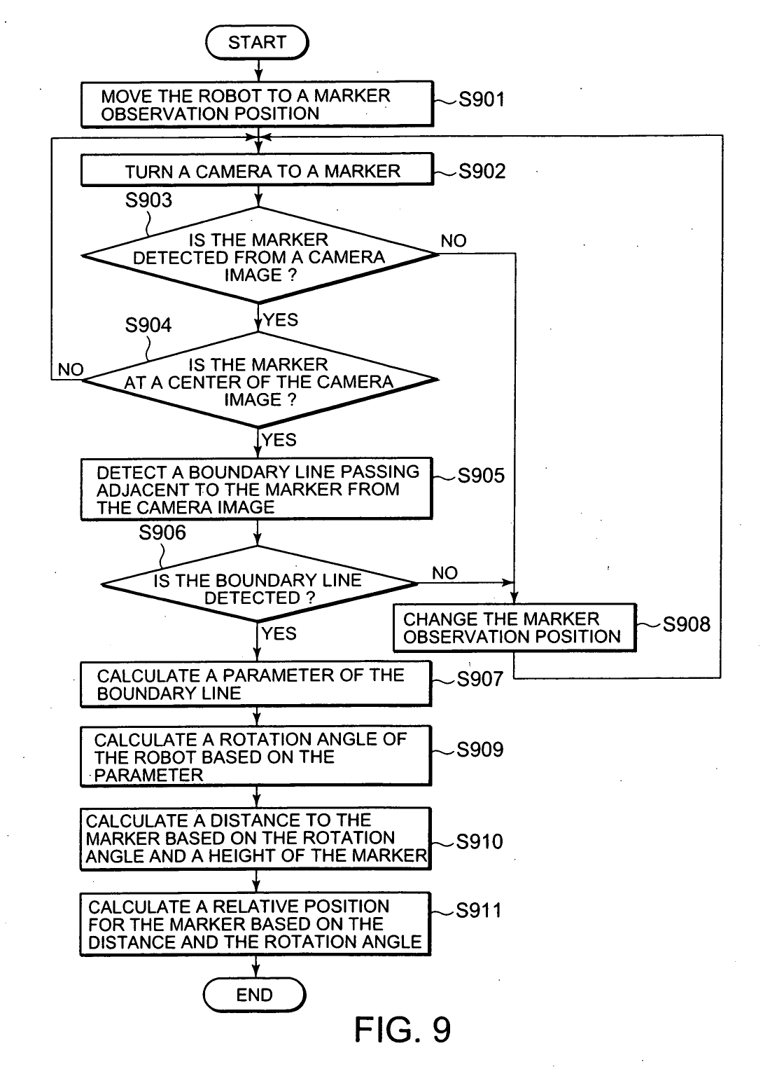

Next, the calculation processing of position and posture (S801, S808) is explained in detail. FIG. 9 is a flow chart of detail processing of calculation of position and posture.

First, the moving control unit 102 controls a moving mechanism to move to an observable position of the marker 130 (S901). Next, the camera direction control unit 103 controls the camera 105 to turn a photographing direction to the marker 130 (S902).

Next, the marker detection unit 111 executes detection processing of the marker 130 from a camera image, and decides whether the marker 130 is detected (S903). As for detection of the marker 130, all methods such as color detection, pattern detection, blinking period detection, or blinking pattern detection, can be applied.

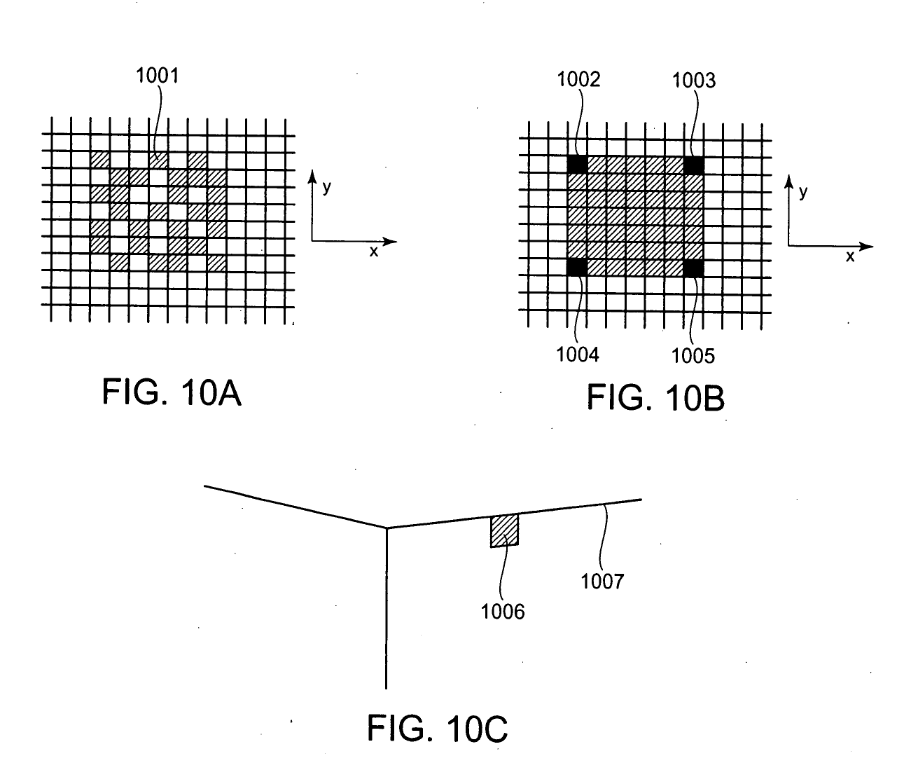

FIGS. 10A, 10B, and 10C show one example of the marker 130 extracted from the camera image. In FIG. 10A, a lattice point 1001 is one pixel. For example, in case of detecting the marker 130 (depart from the camera position) from the image, FIG. 10A shows a detection status of the marker 130 from which pixels are partially broken because of a noise or an illumination condition.

Furthermore, in case that broken neighboring pixels (at least two) are a part of the marker 130, as shown in FIG. 10B, a pixel area of the marker 130 (Hereinafter, a marker pixel area) is extracted using an area combination (broken pixel is set as a part of the marker 130) and an isolated point elimination (isolated point is eliminated from the marker 130). In FIG. 10B, a rectangle area surrounded by a left upper corner 1002, a right upper corner 1003, a left lower corner 1004 and a right lower corner 1005, is specified as the marker pixel area.

FIG. 10C shows a location status of a marker 1006 having a top side touching a boundary line 1007 between a wall and a ceiling. In this case, the boundary line detection unit 112 detects a line passing through the left upper corner 1002 and the right upper corner 1003 as a boundary line. In this way, information of the left upper corner 1002, the right upper corner 1003, the left lower corner 1004, and the right lower corner 1005 is used to raise the accuracy of boundary line detection. Detection processing of boundary line is explained afterwards.

In case of not detecting the marker 130 (No at S903), the moving control unit 102 changes a marker observable position of the camera (S908), and repeats turn processing of the camera (S902).

In case of detecting the marker 130, the marker detection unit 111 decides whether the marker 130 exists at a center of the image (S904). In case of not existing at a center of the image (No at S904), in order for a photographing direction of the camera 105 to locate the marker 130 at a center of the image, turn processing of the camera is repeated (S902).

The marker 130 is positioned at the center of an image because the center of the image is not affected by lens distortion. In addition to this, detection accuracy of marker position (boundary line position) raises.

In case of detecting the marker 130 at a center of the image (Yes at S904), the boundary line detection unit 112 detects a boundary line passing through the marker 130 from the camera image (S905). Hereinafter, detailed processing of detection of the boundary line is explained.

First, by executing edge-detection processing to the camera image, edges are detected from the camera image. The edge is a boundary line between a bright part and a dark part on the image. Furthermore, by executing Hough transformation to the edges, a straight line along which the edges are arranged is detected.

Next, a boundary line passing adjacent to the marker is detected from straight lines detected. In this case, the boundary line passing adjacent to the marker is a line passing into the marker pixel area and having the most edges.

As shown in FIG. 10B, by using the left upper corner 1002, the right upper corner 1003, the left lower corner 1004, and the right lower corner 1005, the accuracy of boundary line detection can be raised. In this case, as shown in FIG. 10C, if a top side of the marker 1006 touches a boundary line 1007 between the wall and the ceiling, in straight lines each passing through the left upper corner 1002 and the right upper corner 1003, a straight line passing into the marker pixel area and having the most edges is selected as a boundary line. In this way, by detecting the boundary line based on the marker position, the boundary line can be certainly detected-with simple processing.

After executing detection processing of a boundary line (S905), the boundary line detection unit 112 decides whether a boundary line is detected (S906). In case of not detecting the boundary line (No at S906), the moving control unit 102 changes a marker observable position of the camera (S908), and repeats turn processing of the camera (S902).

In case of detecting the boundary line (Yes at S906), the parameter calculation unit 113 calculates a parameter of the boundary line on the camera image (S907). As the parameter, a slope “a” of the boundary line on the image is calculated. By extracting two points from the boundary line, assume that a difference between X-coordinates of the two points is “dxd” and a difference between Y-coordinates of the two points is “dyd”. The slope “a” of the boundary line is calculated as “a=dyd/dxd”.

Next, in order to calculate position/posture of the robot 100, processing of following steps (S909˜S911) is executed.

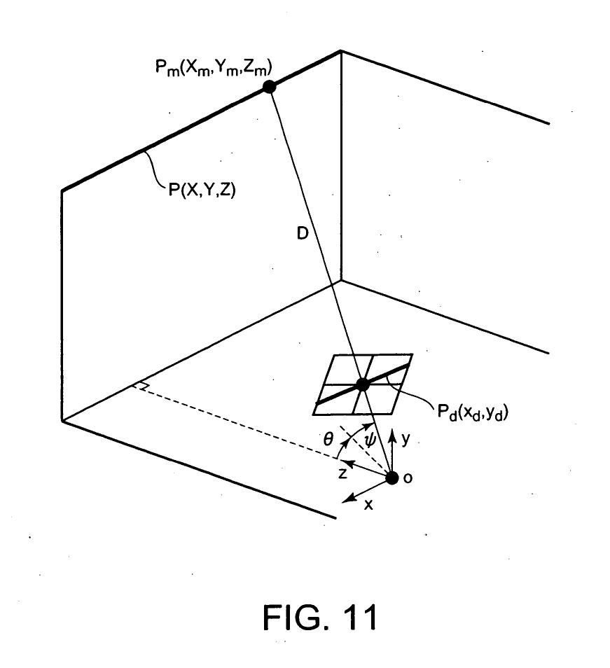

FIG. 11 shows one example of a coordinate system used for calculation of position/posture of the robot 100. As shown in FIG. 11, an X axis and a Y axis exist on a plane where the robot 100 is moving, and the X axis is in parallel with one face of the wall. A base point O is a camera focus, and an optical axis of the camera centering around the base point O turns to a direction that an angle from a straight line perpendicular to the one side of the wall on the plane is θ and an elevation from the plane is φ. Furthermore, assume that a coordinate of the marker 130 is Pₘ (Xₘ, Yₘ Zₘ), a distance from the marker 130 to the base point O is D, a boundary line is P (X, Y, Z), and a projection point of the boundary line P onto the camera image is P_{d} (X_{d}, Y_{d}).

In order to calculate a position of the robot 100, a relative position of the base point O (location point of the robot 100) from the marker 130, i.e., (Xₘ, Yₘ Zₘ), should be calculated. Furthermore, in order to calculate a posture of the robot 100, θ and φ should be calculated. In this case, φ is same as a rotation angle around a camera-tilt rotation direction. Accordingly, only φ is necessary to be calculated.

First, the position posture calculation unit 114 calculates a rotation angle θ of the mobile robot 100 based on the parameter of the boundary line (S909). Calculation of the rotation angle θ is executed as follows.

First, assume that a line that a coordinate of the boundary line P (X,Y,Z) is converted onto a screen coordinate system is P′. The following equation (1) is then realized. In the equation (1), R (x, θ) represents θ rotation matrix around X axis, and R (y, θ) represents θ rotation matrix around Y axis.
P′=R(x, −φ) R(y, −θ) P (1)

Furthermore, P_{d} is represented as following equation (2) using P′ and a projection matrix A.
\overline{P}_{d}=A\overline{P}′ (\overline{P} represents extension vector of P)

In the equation (2), P_{d} (X_{d,} Y_{d}) is represented using X, Y, Z, θ, and φ. In the case that the projection matrix A is represented as following equation (3) using a camera focus distance f, a slope “dyd/dxd” of the boundary line on the image is calculated by following equation (4).

$$\begin{matrix}A = ( \begin{matrix}f & 0 & 0 & 0 \\ 0 & f & 0 & 0 \\ 0 & 0 & 1 & 0\end{matrix} ) & ( 3 ) \\ \frac{ⅆ {y}_{d}}{ⅆ {x}_{d}} = \frac{ⅆ {y}_{d}}{ⅆ X} / \frac{ⅆ {x}_{d}}{ⅆ X} = \frac{Y sin θ}{Y sin ψ cos θ - Z cos ψ} & ( 4 )\end{matrix}$$

The slope calculated by the equation (4) is equal to a slope “a” of the boundary line detected by image processing. Accordingly, following equation (5) is realized.

$$\frac{Y sin θ}{Y sin ψ cos θ - Z cos ψ} = a \qquad ( 5 )$$

Next, the marker 130 is located at a center of the camera. Accordingly, relationship among Pₘ (Xₘ, Yₘ, Zₘ), D, θ and φ, is represented as following equation (6).
Xm=D cos φ sin θ
Ym=D sin φ
Zm=D cos φ cos θ (6)

Values of the slope “a” and the angle “φ” are known. Accordingly, by using the equations (5) and (6), angle “θ” of posture of the moving robot 100 can be calculated.

Next, the position posture calculation unit 114 calculates a distance D from the robot 100 (camera position) to the marker 130 based on the rotation angle (calculated at S909) and a height of the marker 130 (S910). By previously storing height data Zₘ from the plane to the ceiling in the map data memory 120 as position data of the marker 130, the distance D can be calculated using the equation (6).

If the camera 105 is a stereo camera, the distance D to the marker 130 can be calculated by the stereo view method. Accordingly, it is not necessary to previously store the height data Zₘ to the ceiling and to calculate the distance D.

Next, the position posture calculation unit 114 calculates a relative position (Xₘ, Yₘ, Zₘ) of the robot 100 from the marker 130 based on the rotation angle θ (calculated at S909) and the distance D (calculated at S910). By assigning the distance D, the rotation angle θ, the evaluation φ (known value) to the equation (6), the relative position (Xₘ, Yₘ, Zₘ) can be calculated.

Next, map data creation processing of the mobile robot 100 of an embodiment is explained. In map data creation processing, before executing autonomous traveling, the robot 100 creates map data of a moving area to autonomously travel and stores the map data in the map data memory 120.

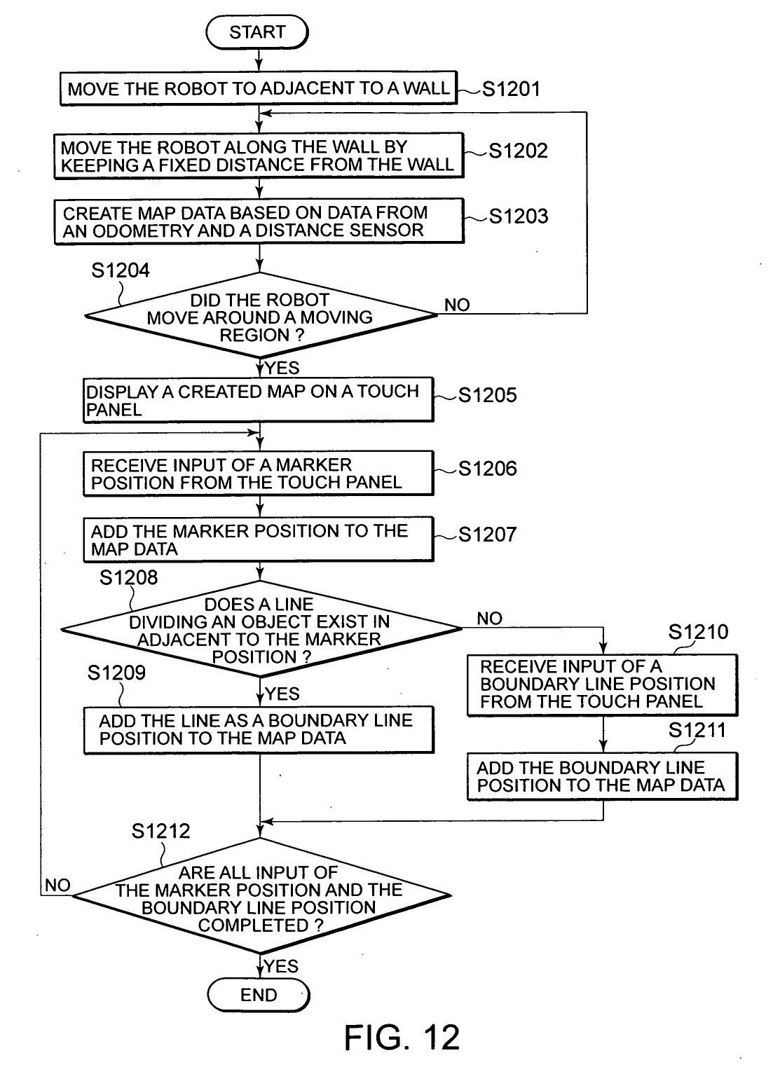

FIG. 12 is a flow chart of map data creation processing of the mobile robot 100 according to one embodiment. First, the moving control unit 102 controls a moving mechanism to move the robot 100 to adjacent to the wall (S1201).

Next, the moving control unit 102 moves the robot 100 along the wall, keeping a fixed distance from the wall (S1202). While moving, the map data creation unit 104 creates map data based on information from the odometry 107 and the distance sensor 106 (S1203).

Next, the moving control unit 102 decides whether the robot 100 moved around the moving region (S1204). In case of not moving around (No at S1204), moving processing is continually executed (S1202). In case of moving around (Yes at S1204), the operation control unit 101 displays a created map on a screen of the touch panel 108 (S1205).

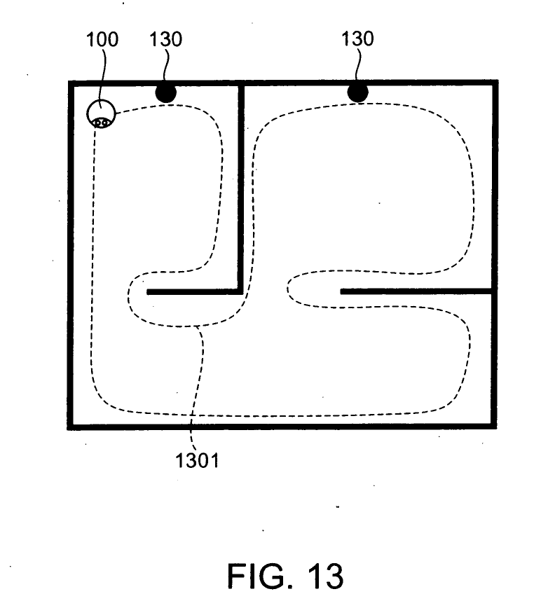

FIG. 13 shows one example of a moving locus of the robot 100 in the map data creation processing. As shown in FIG. 13, the robot 100 moved along the wall of the moving region where two markers 130 are located, and the moving locus of the robot 100 is represented as a dotted line 1301.

Map data created from such moving locus is a map shown in FIG. 2. The screen of the touch panel 108 displays the map shown in FIG. 2.

After displaying the map created at S1205, the operation control unit 101 receives a user's input of a marker position from the touch panel (S1206). Next, the map data creation unit 104 decides whether a line dividing an object (such as a wall) exists adjacent to the marker 130 (S1208). If the line exists (Yes at S1208), the map data creation unit 104 adds the line as a boundary line corresponding to the marker 130 to the map data (S1209).

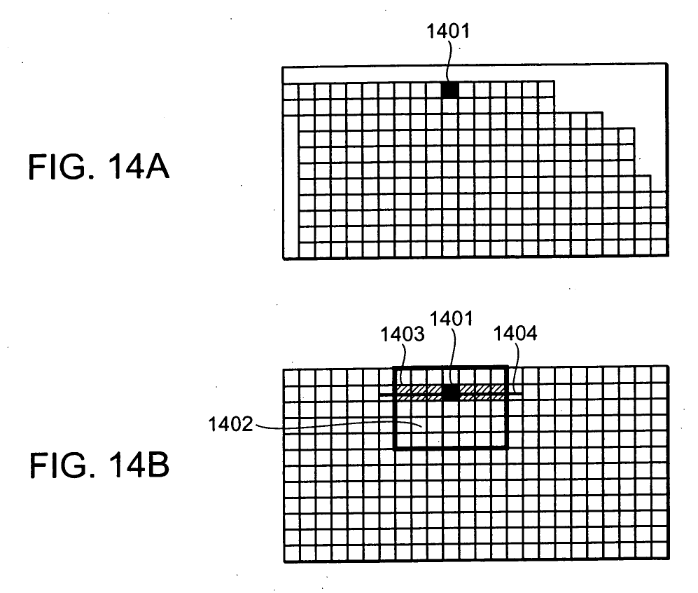

FIGS. 14A and 14B show one example of detection processing of a line adjacent to the marker 130. In FIGS. 14A and 14B, map data shown in FIG. 2 is enlarged.

When a user indicates one lattice point 1401 on the map (S1206), the map data creation unit 104 extracts a window 1402 of lattices (fixed number) centered around the lattice point 1401 from the map data. Next, the map data creation unit 104 extracts a boundary area 1403 between a movable region and a non-movable region for the robot 100 from the window 1402. Based on a position of the boundary area 1403, the map data creation unit 104 calculates a boundary line 1404 using the method of least squares, and adds the boundary line 1404 to the map data (S1209).

In case of not existing the line (No at S1208), the operation control unit 101 receives a user's input of a boundary line position from the touch panel 108 (S1210). Briefly, in case of not detecting a line dividing the object (wall) from a neighboring area of the marker 130, the user can input the boundary line by hand operation. Next, the map data creation unit 104 adds position data of the boundary line to the map data (S1211).

After adding the boundary line position to the map data (S1209, S1211), the operation control unit 101 decides whether all inputs of the marker positions and the boundary line positions are completed (S1212). In case of not completing all input (No at S1212), input of the marker position is received again and addition processing is repeated (S1206). In case of completing all input (Yes at S1212), the map data creation processing is completed.

As mentioned-above, in the mobile robot 100, from an image photographed by a camera, a marker identifiable by a light emitting pattern and a boundary line adjacent to the marker are detected. Based on the boundary line and map data (position data of the marker and the boundary line) previously stored in a memory, a position and a posture of the robot 100 are calculated. Accordingly, even if a few markers exist in a moving region, the position and the posture of the robot 100 can be accurately calculated. As a result, the markers (a few numbers) are easily set in the moving region and outward appearance of the moving region makes a good show.

Furthermore, on a map (created by the robot 100) displayed on a screen, map data is hand-operatively created by indicating position data of the markers (a few numbers). Accordingly, input working of an indoor shape map and coordinates of the markers is not necessary. As a result, the user's burden for map data creation can be reduced.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), or an optical magnetic disk (MD and soon) can be used to store instructions for causing a processor or a computer to perform the processes described above.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A mobile robot comprising:
a map data memory configured to store map data of a movement region, position data of a marker at a predetermined place in the movement region, identification data of the marker, and position data of a boundary line near the marker in the movement region;
a marker detection unit configured to detect the marker from an image, based on the position data of the marker and the identification data;
a boundary line detection unit configured to detect the boundary line near the marker from the image;
a parameter calculation unit configured to calculate a parameter of the boundary line in the image; and
a position posture calculation unit configured to calculate a position and a posture of the mobile robot in the movement region, based on the parameter and the position data of the boundary line.

2. The mobile robot according to claim 1,
wherein said boundary line calculation unit extracts an area of the marker from the image, and extracts the longest line passing through the area from the image as the boundary line, the longest line dividing the image into a plurality of areas.

3. The mobile robot according to claim 1,
wherein said position posture calculation unit calculates a rotation angle of the mobile robot centered around an axis perpendicular to a plane of the movement region, based on a slope of the boundary line in the parameter, and calculates a relative position of the mobile robot from the maker, based on the rotation angle and a height of the marker in the position data of the marker.

4. The mobile robot according to claim 1,
further comprising a plurality of cameras;
wherein said marker detection unit calculates a distance from the mobile robot to the marker, based on a stereo image captured by the plurality of cameras, and
wherein said position posture calculation unit calculates a rotation angle of the mobile robot centering around an axis perpendicular to a plane of the moving region, based on a slope of the boundary line in the parameter, and calculates a relative position of the mobile robot from the maker, based on the rotation angle and the distance.

5. The mobile robot according to claim 1, further comprising:
a display operation unit configured to display the map data, and to receive an input of position data of a marker on the map data; and
a map data creation unit configured to extract a boundary line neighbored with the marker from the map data when said display operation unit receives the input of the position data of the marker, and correspondingly store the boundary line and the position data of the marker in said map data memory.

6. The mobile robot according to claim 1, further comprising:
a moving control unit configured to calculates a path to a destination, based on the map data and the position and the posture of the mobile robot, and to control the mobile robot to move to the destination along the path.

7. The mobile robot according to claim 1, further comprising:
a camera; and
a camera control unit configured to calculate a position of the marker, based on the map data and the position and the posture of the mobile robot, and to point the camera toward the marker.

8. The mobile robot according to claim 7,
wherein said camera control unit centers the marker in the image.

9. The mobile robot according to claim 1,
wherein the identification data of the marker is an interval of light emission or an order of light emission of a plurality of light emitting elements in the marker.

10. A method for calculating a position and a posture of a mobile robot, comprising:
storing map data of a movement region, position data of a marker at a predetermined place in the movement region, identification data of the marker, and position data of a boundary line near the marker in the movement region;
detecting the marker from an image, based on the position data of the marker and the identification data;
detecting the boundary line near the marker from the image;
calculating a parameter of the boundary line in the image; and
calculating a position and a posture of the mobile robot in the movement region, based on the parameter and the position data of the boundary line.

11. The method according to claim 10,
wherein detecting the boundary line comprises,
extracting an area of the marker from the image; and
extracting the longest line passing through the area from the image as the boundary line, the longest line dividing the image into a plurality of areas.

12. The method according to claim 10,
wherein calculating a position and a posture comprises,
calculating a rotation angle of the mobile robot centering around an axis perpendicular to a plane of the movement region, based on a slope of the boundary line in the parameter; and
calculating a relative position of the mobile robot from the maker, based on the rotation angle and a height of the marker in the position data of the marker.

13. The method according to claim 10,
wherein detecting the marker comprises,
calculating a distance from the mobile robot to the marker, based on a stereo image;
wherein calculating a position and a posture comprises,
calculating a rotation angle of the mobile robot centering around an axis perpendicular to a plane of the moving region, based on a slope of the boundary line in the parameter; and
calculating a relative position of the mobile robot from the maker, based on the rotation angle and the distance.

14. The method according to claim 10, further comprising:
displaying the map data;
receiving an input of position data of a marker on the map data;
extracting a boundary line near the marker from the map data when the input of the position data of the marker is received; and
storing the boundary line and the position data of the marker in correspondence.

15. The method according to claim 10, further comprising:
calculating a path to a destination, based on the map data the position and the posture of the mobile robot; and
moving the mobile robot to the destination along the path.

16. The method according to claim 10, further comprising:
calculating a position of the marker, based on the map data and the position and the posture of the mobile robot; and
pointing a camera toward the marker.

17. The method according to claim 16, further comprising:
centering the marker in the image.

18. The method according to claim 10,
wherein the identification data of the marker is an interval of light emission or an order of light emission of a plurality of light emitting elements in the marker.

19. A marker located in a movement region of a robot, the marker being detected by the robot and used for calculating a position and a posture of the robot, comprising:
a plurality of light emitting elements; and
a drive unit configured to drive the plurality of light emitting elements to emit at a predetermined interval or in predetermined order as identification data of the marker.

20. The marker according to claim 19,
wherein the light emitting element is an infrared ray emitting element.
